(19) United States
(12) Patent Application Publication
(10) Pub. No.: US 2010/0256017 A1
(43) Pub. Date: Oct. 7, 2010

(54) SUPRAMOLECULAR NANOSTAMPING PRINTING DEVICE

(76) Inventors: Harry Benjamin Larman, Falmouth, ME (US); Francesco Stellacci, Somerville, MA (US)

Correspondence Address: MORRISON & FOERSTER LLP, 425 MARKET STREET, SAN FRANCISCO, CA, 94105-2482, US

(21) Appl. No.: 12/678,738

(22) PCT Filed: Sep. 17, 2008
(86) PCT No.: PCT/US08/76723

§ 371 Date: Jun. 7, 2010

Related U.S. Application Data
(60) Provisional application No. 60/994,226, filed on Sep. 17, 2007.

(51) Int. Cl. C40B 60/14

(52) U.S. Cl. 506/40

(57) ABSTRACT

A printing device for fabricating hydrogel based microarrays by a nanostamping process is provided. Features of a preferred printing device include: maintaing consistent temperature profile during contact; reproducible temperature profile during separation; constant and uniform pressure profile during contact; and parallelism tolerance during conditions where the gimbal is slightly offset.

### RELATED APPLICATIONS

This application is a 371 National Phase application of PCT/US2008/076723, entitled SUPRAMOLECULAR NANOSTAMPING PRINTING DEVICE, filed on Sep. 17, 2008, which claims the benefit of U.S. Provisional Application No. 60/994,226, filed Sep. 17, 2007, all of which are incorporated herein by reference in their entireties.

### TECHNICAL FIELD OF THE INVENTION

The present application relates generally to a printing device. In particular, the invention relates to a printing device for supramolecular nanostamping (SuNS) on to hydrogel arrays.

### BACKGROUND OF THE INVENTION

The analysis of biospecific agents (e.g., small molecules; proteins; and ligands) that selectively interact with biomolecules, such as by catalysis, binding, proteolysis, or other biological interactions, is of particular interest in medicinal chemistry. Such an analysis can be used for diagnostic and therapeutic applications as well as for biomolecule characterization, screening for biological activity, and other functional studies.

Arrays of biomolecules, such as arrays of peptides or arrays of polynucleotides are useful for this type of analysis. Such arrays include regions (sometimes referred to as spots) of usually different sequence biomolecules arranged in a predetermined configuration on a substrate. The arrays, when exposed to a sample, will exhibit a pattern of binding or activity that is indicative of the presence and/or concentration of one or more components of the sample, such as an antigen in the case of a peptide array or a polynucleotide having a particular sequence in the case of a polynucleotide array. The binding pattern can be detected by, for example, labeling all potential targets (e.g., DNA) in the sample with a suitable label (e.g., a fluorescent compound), and observing a signal pattern (e.g., fluorescence) on the array.

Patterned micro- or nanostructure devices have wide-ranging commercial, medical, and research uses. In a microarray, certain molecules are immobilized within discrete known regions on a substrate. The microarray is made using a method of sequentially synthesizing a probe material on a substrate or a spotting method in which a previously-synthesized probe material is immobilized on an activated substrate.

Examples of such a microarray include polynucleotide and protein microarrays. DNA microarrays (commonly referred to as gene chips) are one example of a commercially available patterned microstructure. Exemplary uses for DNA microarrays include gene expression studies and SNP (single nucleotide polymorphism) detection systems. U.S. Pat. No. 5,143,854 teaches the attachment of proteins in discrete spots as an array on a glass plate and mentions a desire to expand such from proteins to create microarrays wherein cells are immobilized. Creating microarrays of living cells on glass slides or other chips is also addressed in U.S. Pat. No. 6,548,263, which patent teaches the use of a glass wafer or the like which is first treated with an aminosilane to create a hydrophillic surface having reactive amino groups, a concept that is now well-known in this art. More specialized arrays have also been developed for use in protein analysis which have focused both upon attaching and displaying proteins as a part of a microarray and upon analyses where DNA arrays are employed for DNA/protein interactions.

Many microarray chips have been developed in the past where probes have been immobilized on a modified glass substrate, a silicon substrate, or the like, at distinct spatial locations, to create an array which presents a large number of different probes. Initially microarrays were developed as a two-dimensional form wherein probes were directly bound on the surface on the substrate. More recently three-dimensional microarrays have been developed using hydrogel materials wherein the microspots may resemble minute hemispheres, the porous structures of which present a three-dimensional framework or matrix. Microarrays of this type are described in U.S. Pat. No. 6,174,683 and in published International Application WO 02/059372. Three-dimensional (3D) microspots have been developed using hydrogels and the like in order to better bind and present proteins as part of such a microarray. WO02/059372 shows a biochip that has been made with a plurality of microspots, in the form of optically clear hydrogel cells, attached to the top surface of the chip. These polymeric hydrogel microspots can be used either to bind proteins for interactions or to bind capture agents or probes that will subsequently react with and/or sequester proteins or peptides applied thereto in solution. For example, antigens may be bound to the surface for attachment to antibodies, or vice versa.

Fabrication of patterned micro- or nano-structure devices presents a number of challenges. For example pattern resolution or fidelity, replication time, replication cost, and yield are all important factors when evaluating a fabrication technique. Fabrication techniques can be conceptual divided into two groups: serial fabrication techniques that typically produce high resolution patterns at the expense of time and/or cost, and parallel fabrication techniques that typically produce the entire desired pattern simultaneously and therefore rapidly, though commonly with a loss of resolution or pattern fidelity when compared to serial techniques. Etching and deposition are examples of serial fabrication techniques; whereas stamping and printing are examples of parallel fabrication techniques. A common method of micro- or nanostructure fabrication involves the serial fabrication of a master array, which is subsequently used to print or stamp multiple copies. Another distinction between fabrication techniques is their suitability for organic (e.g., DNA or protein) or “soft” pattern fabrication. Certain techniques may be suited only for inorganic (e.g., metals and semiconductors) or “hard” pattern fabrication.

While microarrays provide a platform for massively parallel assays for qualitative gene expression their use in clinical settings which require consistent quantitative measurements have been lacking. It has been observed that groups of genes detected as differentially expressed on a particular microarray platform are often not reproducible across microarray platforms (Shippy, R. et al. BMC Genomics 5, 61 (2004)). A source of variability is the limited and variable sensitivity of the different microarray platforms for detecting weakly expressed genes, which affect interplatform reproducibility of differentially expressed genes.

Current methods for nucleic acid synthesis uses a traditional monomer-by monomer approach. Nucleic acid probes used in oligonucleotide DNA microarrays are synthesized in this manner at high cost and the low reproducibility. Thus, there is considerable variability between microarrays fabricated in this manner that carry identical sets of probes. This hinders widespread and reliable use of microarrays in research and clinical settings. Therefore, there is a need to develop a microarray platform that is consistent and reproducible in the quality of each probe associated with the microarray.

Specific molecules can spontaneously arrange on various surfaces forming two-dimensional mono-molecular layers called self-assembled monolayers (SAMs). Patterned DNA SAMs can be used as masters for a novel printing technique for organic materials called Supramolecular NanoStamping (SuNS). Supramolecular NanoStamping (SuNS) is a newly developed stamping technique that enables the transfer of spatial together with chemical information from a master containing DNA features to a secondary substrate. (Yu A A et al. J. Mater. Chem., (2006) 16, 2868-2870). This method, like the DNA/RNA information transfer, uses the reversible assembly of DNA double strands as a way of transferring patterns from a surface to another. The method relies on the biochemical ability of DNA to replicate and avoids the reproducibility problems associated with traditional monomer-by monomer chemical synthesis of nucleic acids to generate microarrays. One of the main advantages of SuNS is that multiple DNA strands each encoding different information can be printed at the same time in parallel. (Yu A A et al. Nano Lett. 2005 June; 5(6):1061-1064).

Described herein are methods of microstructure fabrication capable of providing pattern densities in excess of the master array. In one embodiment, the methods provided herein may be used to fabricate DNA microarrays with a probe density greater than that of the patterned DNA master array used in fabrication.

### SUMMARY OF THE INVENTION

A feature of SuNS is the flexibility of substrate material onto which DNA molecules may be printed. A good substrate shall have properties such that it simultaneously (a) provides ideal conditions for SuNS printing, and (b) optimizes microarray assay performance. The present invention relates to the discovery that the surface of a hydrogel polymer is the ideal substrate that satisfies these criteria.

There are essentially two technical challenges to consider with any SuNS approach. The first challenge is to achieve nanometric conformal contact between two surfaces over a macroscopic area. Existing strategies include a deformable PDMS substrate with built-in drainage canals developed by Crooks et al. (Lin H et al. J Am Chem Soc. 2005 Aug. 17; 127(32):11210-1) as well as a liquid prepolymer strategy pioneered by Stellacci et. al. The second major challenge of SuNS is to minimize damage to the template DNA which may result from repeated cycles of surface-to-surface contact. While literature exists for related systems (Burnham M R et al. Biomaterials. 2006 27(35):5883-91; Mitra R D et al. Nucleic Acids Res. 1999 Dec. 15; 27(24):e34), the inventor of the present invention is the first to overcome these two challenges simultaneously of SuNS by printing onto the surface of a hydrogel. The deformability of the gel permits large-area conformal contact, while many non-destructive printing cycles are possible, due to the protective effects of the gel layer.

Described herein is a method of manufacturing a patterned hydrogel array, the method having the steps of: contacting a patterned substrate with a hydrogel substrate to form a substrate complex; the patterned substrate having: a surface; and a first polymer covalently attached to the surface, the first polymer having a sequence of polymer subunits; the hydrogel substrate having: a polymer matrix having a polymer weight-volume percentage of less than 10%; a second polymer covalently attached to the polymer matrix at a defined position; the second polymer is capable of binding the first polymer and has a sequence of polymer subunits complimentary to at least a portion of the sequence of polymer subunits of the first polymer; and subjecting the substrate complex to a polymer extension cycle.

The polymer extension cycle may comprise the steps of: binding the first polymer to the second polymer to form a dimer having a first polymer portion and second polymer portion; extending the second polymer portion of the dimer using the sequence of polymer subunits of the first polymer portion as a template; disassociating the dimer to form an extended second polymer and to re-form the first polymer; and separating the substrate complex to obtain a patterned hydrogel array having an extended second polymer covalently attached at the defined position.

### DESCRIPTION OF DRAWINGS

FIG. 1A illustrates formation of a hydrogel comprising oligonucleotide primers and wetted with nucleic acid polymerase and dNTPs in solution.

FIG. 1B illustrates contacting the master template array with the hydrogel comprising primer oligonucleotides.

FIG. 1C illustrates primer extension on the hydrogel replicate in contact with the master template microarray.

FIG. 2 illustrates an exemplary printing device for supramolecular nanostamping on hydrogel substrates.

### DETAILED DESCRIPTION OF THE INVENTION

The following description sets forth numerous exemplary configurations, parameters, and the like. It should be recognized, however, that such description is not intended as a limitation on the scope of the present invention, but is instead provided as a description of exemplary embodiments.

### Patterned Hydrogel Array Fabrication

According to this invention, the replica printed surface comprises a hydrogel coating that allows conformal contact between the stamp and the replica, prevents damage to the template DNA, improves the efficiency of the hybridization process, and allows fast linkage of the replica DNA strands to the hydrogel coating.

The present invention takes advantage of the fact that a low percentage hydrogel has a viscosity and wetting properties similar to water, such that bringing this object into conformal contact with a DNA microarray will not damage it. In a preferred embodiment, primers have been covalently incorporated into the gel matrix, so that they are mobile, but only within a distance similar to the distance between crosslinks. Once the hydrogel is in contact with the surface of the master microarray, the primers are allowed to anneal with the master strands. The hydrogel is previously or concurrently wetted with a solution containing DNA polymerase and dNTPs, the primers are then extended along the template master strands. A key advantage of this approach is that thermal cycling of the system saturates all of the available primers. The resultant microarray embedded within the hydrogel contains a much higher number of probes per site as compared to the original master microarray.

Described herein are methods for fabricating a patterned hydrogel array that incorporates a polymer pattern based on the polymer pattern of a master array.

In one embodiment, the patterned hydrogel array is fabricated by contacting a hydrogel substrate with a master array, having a polymer pattern of interest.

In one embodiment, the master array is contacted with one or more extendable polymers and is subjected to a polymer extension cycle prior to contact with the hydrogel substrate.

In another embodiment, the hydrogel substrate contains one or more covalently-linked, extendable primers capable of binding to the polymers of the master array.

In an embodiment in which the master array was not subjected to a polymer extension cycle, the hydrogel substrate-master array complex is then subjected to one or more polymer extension cycles. The hydrogel substrate is separated from the master array, resulting in a patterned hydrogel array with a greater density of patterned polymers than the master array on which it is based.

Patterning polymers that may used with the methods described herein include, but are not limited to, modified or unmodified DNA molecules, modified or unmodified RNA molecules, modified or unmodified proteins, an the like.

The hydrogels for use with the present methods include, but are not limited to, polyacrylamide hydrogels, polydimethylsiloxane hydrogels, urethane-based polymer hydrogels, and the like.

A “hydrogel array” is a combination of two or more microlocations. Preferably an array is comprised of microlocations in addressable rows and columns. Such a hydrogel array as contemplated herein is known in the art, and referred to by a variety of names (e.g., “gel pad array”, “polyacrylamide array”, etc.). The thickness and dimensions of the polymer hydrogel and/or hydrogel arrays produced according to the invention can vary dependent upon the particular needs of the user. Optionally, however, with incorporation into a hydrogel array, the hydrogel microlocations will each have a thickness of less than about 20 microns, desirably a thickness of between about 0.2 and about 40 microns, even more preferably a thickness of between about 1 and about 30 microns, and optimally, will be about 5 microns thick. Furthermore, the hydrogel microlocations in an array are each from about 5 to about 500 microns in size, particularly from about 50 to about 400 microns, and especially from about 100 to about 200 microns.

Preferably, the hydrogel used has a viscosity and wetting properties similar to that of water. More preferably, the low weight/volume percent hydrogel allows for contact between the hydrogel and the master array without imposing a significant amount of damage to the patterned polymers of the master array. Desirably, the polymer hydrogel or polymer hydrogel array according to the invention is coated onto a solid support. Namely, desirably the polyacrylamide reactive prepolymer is first produced, and then is deposited on the surface of the solid support by any appropriate means.

Polymer extension may be performed by any means suitable for the selected polymers. In one embodiment employing DNA polymers, extension may be performed through the addition of DNA polymerase and deoxyribonucleotide triphosphates. Polymerase chain reaction thermocycles are performed to extend the covalently-linked, extendable polymers of the hydrogel.

According to this invention, a “biomolecule” (i.e., a biological molecule) is any molecule that can be attached to a hydrogel (e.g., a polyacrylamide hydrogel) or solid support, using the methods of the invention. Preferably, however, a biomolecule is selected from the group consisting of: nucleic acid such as DNA or RNA or PNA molecule (or fragment thereof), polynucleotide, or oligonucleotide, and any synthetic or partially synthetic modification of any nucleic acid; peptide, polypeptide, oligopeptide, or protein, and any modification thereof; lipids, and any modification thereof; polysaccharide, and any modification thereof; or any combination (i.e., within the same molecule) of the foregoing entities.

A “biopolymer” is a polymer of one or more types of repeating units. Biopolymers are typically found in biological systems and particularly include polysaccharides (such as carbohydrates), peptides (which term is used to include polypeptides and proteins) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides.

Preferred recognition components and their targets include nucleic acid/complementary nucleic acid, antigen/antibody, antigen/antibody fragment, avidin/biotin, streptavidin/biotin, protein A/Ig, lectin/carbohydrate and aptamer/target. As used herein, “aptamer” refers to a non-naturally occurring nucleic acid that binds selectively to a target.

Biopolymers include DNA (including cDNA), RNA, oligonucleotides, and PNA and other polynucleotides as described in U.S. Pat. No. 5,948,902 and references cited therein (all of which are also incorporated herein by reference), regardless of the source. An “oligonucleotide” generally refers to a nucleotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (e.g., a single amino acid or nucleotide with two linking groups one or both of which may have removable protecting groups).

Immobilization of biomolecules (e.g., DNA, RNA, peptides, and proteins, to name but a few) through chemical attachment on a solid support or within a matrix material (e.g., hydrogel, e.g., present on a solid support) has become a very important aspect of molecular biology research (e.g., including, but not limited to, DNA synthesis, DNA sequencing by hybridization, analysis of gene expression, and drug discovery) especially in the manufacturing and application of microarray or chip-based technologies. Typical procedures for attaching a biomolecule to a surface involve multiple reaction steps, often requiring chemical modification of the solid support itself, or the hydrogel present on a solid support, in order to provide a proper chemical functionality capable forming a covalent bond with the biomolecule. The efficiency of the attachment chemistry and strength of the chemical bonds formed are critical to the fabrication and ultimate performance of the microarray.

In some embodiments, a biomolecule of the invention is a nucleic acid or fragment thereof containing less than about 5000 nucleotides, especially less than about 1000 nucleotides. Desirably, a biomolecule of the invention is an oligonucleotide. Preferably a biomolecule of the invention (i.e., including a biomolecule other than a nucleic acid) optionally comprises a spacer region. Optimally, a biomolecule has been functionalized by attachment of a reactive site, as further described herein. In some cases, the biomolecule already contains a reactive site with no further modification needed (e.g., certain nucleic acid species that incorporate pyrimidines such as thymine, or are modified to contain thymine or polythymine, or proteins incorporating thiols).

### Hydrogel Labeled Primer Extension (HLPE)

When employed in the fabrication of hydrogel DNA microarrays, the methods described herein may be referred to as hydrogel labeled primer extension (HLPE). Broadly, HPLE employs the use of a DNA master array, a low percentage hydrogel substrate incorporating covalently linked oligonucleotide primers, and polymerase chain reaction (PCR) thermocycling to yield a hydrogel microarray potentially having a greater density of DNA probes, arrayed in a desired pattern, than the master array from which the hydrogel is “stamped.”

### A. Master Array Preparation

Master microarrays can be fabricated using drop deposition from pulse-jets of either polymer precursor units (for example, nucleotide monomers for a nucleic acid polymer) in the case of in situ fabrication, or a previously obtained polymer (for example, a polynucleotide). Array fabrication methods include robotic contact printing, ink-jetting, piezoelectric spotting and photolithography. A number of commercial arrayers are available [e.g. Packard Bioscience] as well as manual equipment [V & P Scientific]. Such methods are described in detail in U.S. Pat. Nos. 6,242,266, 6,232,072, 6,180,351, 6,171,797, 6,323,043 and references cited therein. Other drop deposition methods can be used for fabrication, as well as other array fabrication methods such as pin spotting and techniques described in U.S. Pat. Nos. 5,599,695, 5,753,788, and 6,329,143.

In one embodiment, the master array has a pattern of biopolymer molecules covalently attached to the array surface. Biopolymer arrays can be fabricated by depositing previously obtained biopolymers (such as from synthesis or natural sources) onto a substrate, or by in situ synthesis methods. Methods of depositing obtained biopolymers include loading then touching a pin or capillary to a surface, such as described in U.S. Pat. No. 5,807,522 or deposition by firing from a pulse jet such as an inkjet head, such as described in PCT publications WO 95/25116 and WO 98/41531. For in situ fabrication methods, multiple different reagent droplets are deposited by pulse jet or other means at a given target location in order to form the final feature which is synthesized on the array substrate). The in situ fabrication methods include those described in U.S. Pat. No. 5,449,754 for synthesizing peptide arrays, and in U.S. Pat. No. 6,180,351 and WO 98/41531 and the references cited therein for polynucleotides, and may also use pulse jets for depositing reagents.

For example, the master microarrays may be produced by a number of means, including “spotting” wherein small amounts of the reactants are dispensed to particular positions on the surface of the substrate. Methods for spotting include, but are not limited to, microfluidics printing, microstamping (see, e.g., U.S. Pat. No. 5,515,131, U.S. Pat. No. 5,731,152, Martin, B. D. et al. (1998), Langmuir 14: 3971-3975 and Haab, B B et al. (2001) Genome Biol 2 and MacBeath, G. et al. (2000) Science 289: 1760-1763), microcontact printing (see, e.g., PCT Publication WO 96/29629), inkjet head printing (Roda, A. et al. (2000) BioTechniques 28: 492-496, and Silzel, J. W. et al. (1998) Clin Chem 44: 2036-2043), microfluidic direct application (Rowe, C. A. et al. (1999) Anal Chem 71: 433-439 and Bernard, A. et al. (2001), Anal Chem 73: 8-12) and electrospray deposition (Morozov, V. N. et al. (1999) Anal Chem 71: 1415-1420 and Moerman R. et al. (2001) Anal Chem 73: 2183-2189).

In one embodiment, the DNA master array has a pattern of DNA molecules covalently attached to the array surface. The pattern may be any desired pattern and the DNA molecules may be DNA polymers having any sequence. The sequences of the polymers may be heterologous or homologous. In one embodiment, the DNA polymers are polymers having a primer binding sequence common to all the polymers.

A number of ways to generate peptide master arrays are known, a few of which are represented below. All of them can be adapted for use in the instant invention, and are all incorporated herein by reference. WO 03/038033A2 describes the use of ultrahigh resolution patterning carried out by dip-pen nanolithographic printing, for constructing peptide and protein nanoarrays with nanometer-level dimensions. U.S. 20020037359A1 relates to arrays of peptidic molecules and the preparation of peptide arrays using focused acoustic energy. A large number of diverse arrays of polypeptides and polymers is synthesized in U.S. Pat. No. 5,143,854 to Pirrung et al. (1992). This patent describes the use of photo lithographic techniques for the solid phase synthesis of arrays of polypeptides and polymers.

Detailed methods for preparing the master array is disclosed in DNA Microarrays Part A: Array Platforms & Wet-Bench Protocols, Volume 410 (Methods in Enzymology (2006); Academic Press, San Diego, Calif.).

In some embodiments the array on the master template is itself amplified prior to replicating on the hydrogel. In some embodiments, thermocycling methods of DNA amplification such as polymerase chain reaction (PCR) or ligase chain reaction (LCR) using thermostable enzymes. In other embodiments, isothermal methods of DNA amplification are used including but not limited to Strand Displacement Amplification (SDA), Helicase Dependent Amplification (HDA), Loop-Mediated Isothermal Amplification (LAMP) and Rolling Circle DNA Amplification (RCA). In L-RCA (ligation-rolling circle amplification) thermostable ligation of circularizable padlock-like DNA probes for allelic SNP discrimination with subsequent RCA procedure for signal enhancement is carried out. In some embodiments, peptide nucleic acid (PNA) oligomers can be employed as site-specific openers of the DNA double helix to locally expose a designated marker sequence inside duplex DNA. Recently, rolling-circle amplification (RCA) with Phi29 DNA polymerase has been applied in vitro to marker DNA sequences (using specific primers) and to circular cloning vectors (using random hexamer primers) to achieve their exponential amplification via DNA strand displacement. (DNA Amplification: Current Technologies and Applications, Vadim V. Demidov and Natalia E. Broude eds. (2004) Horizon Scientific Press, UK)

### B. Hydrogel Preparation

Hydrogels are a class of polymer materials that can absorb large amounts of water without dissolving. The latter is due to physical or chemical crosslinkage of the hydrophilic polymer chains. Hydrogels can be prepared starting from monomers, prepolymers or existing hydrophilic polymers. The present invention generally relates to hydrogels and blends which are generally known in the polymer art. See, for example, (1) Contemporary Polymer Chemistry, Allcock and Lamp, Prentice Hall, 1981, and (2) Textbook of Polymer Science, 3rd Ed., Billmeyer, Wiley-Interscience, 1984.

In the present invention, polymer blends can be prepared by mixing two or more polymers together including binary and ternary blends. Blends can be formulated in the present invention to provide high quality thin layers. The polymers can be in a variety of forms including, for example, homopolymers, copolymers, crosslinked polymers, network polymers, short chain or long chain branched polymers, interpenetrating polymer networks, and other types of mixed systems known in the polymer art. The polymer blends can swell when exposed to aqueous environments and form hydrogel states characterized by pore size and high water content.

Copolymerisation of hydrophilic monomers and polyfunctional comonomers, acting as crosslinkers, leads to the formation of hydrophilic network structures. Most commonly used monomers are hydrophilic (meth)acrylates and (meth)acrylamides (Schacht E 1987 Int. Pharm. J. 1:3). One of the first examples reported in the literature (Wichterle O and Lim D 1960 Nature 185 117-8) was a copolymer of (2-hydroxyethyl)methacrylate (HEMA) and ethyleneglycol bismethacrylate (EGDMA). The resulting hydrogel has been used for the production of soft contact lenses and as reservoir for drug delivery. Crosslinked copolymers of acrylamide and methylene bisacrylamide are daily used to prepare gels for electrophoresis. Polymerization of vinyl monomers is most frequently initiated via radical initiators (peroxides, azo-compounds). Radicals are generated by heating, by the use of a redox initiator (e.g. ammonium persulfate+N,N′-tetramethyl ethylenediamine, TEMED) or a photoinitiator. An alternative way to initiate the radical polymerisation process is by high energy irradiation.

Hydrogels have been prepared by crosslinkage of low molecular weight hydrophilic prepolymers or oligomers. One example is the reaction of α,ω-hydroxyl poly(ethylene glycol) with a diïsocyanate in the presence of a triol as crosslinker (Van Bos M, Schacht E 1987 Acta Pharm. Technol. 33(3):120; Graham N B 1987 Hydrogels in Medicine and Pharmacy vol. 2 ed Peppas N A (CRC Press, Boca Raton) chapter 4). This reaction leads to the formation of crosslinked hydrophilic polyurethanes. An alternative approach is the conversion of the hydroxyl end groups of poly(ethylene glycol) into (meth)acrylate which can then be crosslinked via radical polymerisation.

Other polymers like gelatin and agarose can form hydrogels upon cooling from an aqueous solution. The gel formation is due to helix-formation and association of the helices, forming junction zones. These physically crosslinked hydrogels have a sol-gel transition temperature. Permanent crosslinkage can be achieved by subsequent chemical crosslinkage. Gelatin chemically modified with methacrylamide side groups can subsequently be polymerized by radical initiators or high energy irradiation. (Van den Bulcke A, Bogdanov B, De Rooze N and Schacht E 2000 Biomacromol. :31)

A hydrogel according to this invention comprises a long-chain, hydrophilic polymer containing amine-reactive groups. This polymer is covalently crosslinked to itself and placed on a support surface such as a slide. In some embodiments, the hydrogel is covalently attached to the surface of the support. On a standard 2-D planar surface, hybridization efficiency is affected by steric hindrance. To overcome this, longer oligonucleotide probes are often necessary. However, longer probes can compromise discrimination and specificity during hybridization. The three-dimensional nature and water-like physical properties of a hydrogel all bases of the probes participate in hybridization and the hybridization kinetics are very similar to those observed in solution-phase hybridization.

In some embodiments, the crosslinked polymer, combined with end-point attachment, orients the immobilized DNA, and holds it away from the surface of the support. This combination makes the DNA more readily available for hybridization and may eliminate the need for poly(dT) or PEG spacers on oligonucleotides. Additionally, the hydrophilic nature of the polymer provides a passivating effect once the DNA has been immobilized resulting in lower background.

Hydrogels have garnered considerable interest as the chemical constituent of microstructures for biological applications. A hydrogel is a three-dimensional polymer, or array of polymers, that is hydrated by water or an aqueous solution. Tanaka, “Gels,” Sci. Am., 244, 124-138 (1981). Typical polymers that comprise hydrogels include proteins and/or sugars. Protein- or sugar-based hydrogels may exhibit properties that resemble those of various biological materials including extracellular matrices, particularly when the protein or sugar is a naturally occurring biological macromolecule. U.S. Pat. No. 6,174,683 discloses a method of rapidly and inexpensively producing a biochip using a polyurethane-based hydrogel in order to immobilize a probe material on a substrate.

The use of enzymes, antibodies, peptides, or other bioactive molecules, e.g. aptamers, has received increasing attention in creating tools for screening in the fields of bioassays and proteomics, and the use of 3-dimensional hydrogel supports for these bioactive materials in microarrays has recently gained in importance. Hydrogels are water-containing polymeric matrices. In particular, hydrogels provide a support for biomaterials that more closely resembles the native aqueous cellular environment, as opposed to a more denaturing environment that results when nucleic acids, proteins or other such materials are directly attached to a solid support surface using some other molecular scale linkages.

Polyacrylamide hydrogels are especially employed as molecular sieves for the separation of nucleic acids, proteins, and other moieties, and as binding layers to adhere to surfaces biological molecules including, but not limited to, proteins, peptides, oligonucleotides, polynucleotides, and larger nucleic acid fragments. In the fabrication of polyacrylamide hydrogel arrays (i.e., patterned gels) used as binding layers for biological molecules, the acrylamide solution typically is imaged through a mask during the UV polymerization/crosslinking step. In an application of lithographic techniques known in the semiconductor industry, light can be applied to discrete locations on the surface of a polyacrylamide hydrogel to activate these specified regions for the attachment of an anti-ligand, such as an antibody or antigen, hormone or hormone receptor, oligonucleotide, or polysaccharide on the surface of a polyacrylamide hydrogel on a solid support (WO 91/07087). Following fabrication of the hydrogel array, the polyacrylamide subsequently is modified to include functional groups for the attachment of moieties, and the moieties (e.g., DNA) later are attached.

Another type of substrate composition that has been used is a polyurethane gel. A polyurethane gel is created from a polyurethane network and a solvent. The polyurethane network envelopes the solvent and can prevent the solvent from flowing out of the network. The properties of a polyurethane gel depend largely on the structure of the polyurethane network that makes up the gel and the interaction of the network and the solvent. The polyurethane network depends on the crosslink structure of the network, which depends on, for example, the amount and type of the reactants used to make the network and their ability to react to near completion. The polyurethane network can be important for determining the strength of the gel and can also be important for the diffusion of molecules through the gel.

U.S. application 2003/0124371 discloses the use of water-swellable hydrophilic hydrogels which are considered to be particularly useful for immobilizing polypeptide analytes onto an absorbent layer, which is engineered by varying the ratio of hydrophilic moieties and hydrophobic moieties in the hydrogel. The hydrophilic and hydrophobic monomers which make up the hydrogel are cross-linked to create a desired polymer. For example, an aluminum substrate is coated with silicon dioxide and then treated with an alkylsilane before the monomers are applied to a plurality of addressable locations (microspots) and then cross-linked by radiation. Probes are added to each microspot on the chip, using a binding buffer, and the loaded chip is incubated for thirty minutes. Washing then readies the chip for use in an assay.

U.S. application 2003/0138649 teaches the fabrication of microarrays suitable for attaching proteins which will serve as probes or capture agents using a gelatin-based substrate. A suitable substrate such as glass or silicon or photographic paper is coated with a solution of type IV gelatin; for example, gelatins were coated onto reflective photographic paper and then chill-set and dried. The plates having the overall gelatin coating are then microspotted to attach bi-functional compounds, e.g. goat anti-mouse antibody IgG, which has a group that will link to the gelatin and a second functional group that is capable of interacting with high specificity with a protein. In U.S. application, No. 2003/0170474, a silicon wafer or glass plate is treated first with an alkylsilane and then dipped in a solution of gelatin. The gelatin-coated substrate is then dipped in a solution of polyethyleneimine (PEI). The surface was reported to have a relatively low nonspecific binding capacity for proteins and that it could be used as a microarray substrate by affixing protein capture agents at microspots spaced across the surface.

U.S. application 2006/0040274 discloses microarrays that can be fabricated by providing a substrate, the upper surface of which is functionalized with organic molecules, and coating that surface with a polymerizable hydrogel layer which contains anchoring moieties disbursed uniformly throughout so as to cover a continuous region of the surface that will serve as a microarray. After curing the coated substrate so as to polymerize the coated hydrogel layer, a variety of different probes are attached at distinct spatial locations on the surface to form microspots, by linking the probes to the anchoring moieties that are present in the cured hydrogel layer.

Microarrays where three-dimensional microspots of hydrogels are employed to serve as holders for the probes or capture agents are described in U.S. Pat. No. 6,174,683 and in published international applications WO 09/059,372, entitled “Three Dimensional Format Biochips”, and WO 02/081662, entitled “Methods and Gel Compositions For Encapsulating Living Cells and Organic Molecules”.

The hydrogel substrate used in HPLE is prepared as a prepolymer mix poured into a gel tray or other suitable support material. The support material used in the form of a flat plate or the like may be selected from, but is not limited to, glass, quartz, silicon, silica, metal, ceramic, stainless steel and inert polymers, such as polyethylenes, polypropylenes, polyacrylics, polycarbonates and the like, as well known in the art.

The prepolymer used may be any suitable prepolymer including, but not limited to, acrylamide; polydimethylsiloxane; urethane-based prepolymer; polyethylene glycol that is end-capped with toluene diisocyanate; a copolymer of ethylene oxide and propylene oxide (optionally with trimethylolpropane) and toluene diisocyanate; toluene diisocyanate-polyethylene glycol-trimethylopropane, methylene diisocyanate-methylene homopolymer; polymeric methylene diisocyanate-polyethylene glycol; polymer of ethylene oxide-propylene oxide-trimethylolpropane and isophorone diisocyanate, and polyethylene glycol trilactate and toluene diisocyanate. Suitable prepolymers of the above types are available from Dow Chemical Company as HYPOL PreMA® G-50, HYPOL® 2000, HYPOL® 3000, HYPOL® 4000 and HYPOL® 5000, which formulations generally include copolymers of polyethylene oxide and a minor amount of polypropylene oxide. Others are available under the trademark Urepol from EnviroChem Technologies, and comparable prepolymers can be prepared from commercially available feedstocks. The main chain of the hydrogel polymer can be comprised of polyethylene glycol, polypropylene glycol, or a copolymer of polyethylene glycol and polypropylene glycol. Non-ionic, hydrophilic properties of polyethylene glycol and polypropylene glycol hydrogels provide for low levels of non-specific binding of analyte to the hydrogel and also provide good compatibility with biomolecules that may be immobilized therewith so as to maintain native conformation and bioreactivity thereof. Polyurethane-based isocyanate-functional hydrogels of this general type are described in U.S. Pat. No. 3,939,123 (Mathews, et al.), U.S. Pat. No. 4,110,286 (Vandegaer, et al.) and U.S. Pat. No. 4,098,645 (Hartdegan, et al.).

The polymerizable hydrogel can be made using isocyanate-functional prepolymers that are prepared from relatively high molecular weight polyoxyalkylene diols or polyols by reacting them with difunctional and/or polyfunctional isocyanate compounds. In some embodiments, prepolymers are ones made from polyoxyalkylene diols or polyols that comprise homopolymers of ethylene oxide units or block or random copolymers containing mixtures of ethylene oxide units and propylene oxide or butylene oxide units. Suitable prepolymers may be prepared by reacting selected polyoxyalkylene diols or polyols with a polyisocyanate so that essentially all of the hydroxyl groups are capped with polyisocyanate. Generally, polyethylene glycol (PEG), polypropylene glycol (PPG) or copolymers thereof are preferred. If relatively low molecular weight prepolymers, e.g. less than 2,000 daltons, are used, they preferably contain a relatively high isocyanate content (about 1 meq/g or even higher). However, the polymerization rate of such smaller prepolymers may require more precise control to avoid too rapid polymerization. Thus, higher molecular weight prepolymers which contain a relatively low isocyanate content may be preferred.

When acrylamide prepolymers are utilized, the hydrogels may contain acrylamide-functionalized carbohydrate, sulfoxide, sulfide or sulfone copolymerized with hydrophilic or hydrophobic copolymerizing material, such as acrylamide, methacrylamide, acrylate, methacrylate or vinyl or their derivatives such as 2-hydroxyethyl methacrylate.

In one embodiment, the prepolymer mix used is an acrylamide mix poured into a glass gel tray. Preferably, the prepolymer is provided in a concentration so as to yield a low percentage hydrogel. In some embodiments, the prepolymer is acrylamide, having a weight per volume (w/v) percentage selected from 15%, 10%, 5%, 4%, 3%, 2%, and 1% w/v.

In some embodiments, the hydrogel contains anchoring moieties dispersed uniformly throughout, which moieties are used to either directly or indirectly anchor the probes as part of a microarray. They may be dissolved in aqueous solution and mixed with a prepolymer to begin the polymerization reaction. Examples of suitable anchoring moieties include organic chelators and organic linkers, which may be one-half of a pair of complementary linkers, such as streptavidin and biotin, the other member of which pair is then attached to the probe of interest.

Besides prepolymer, the mix may also include at least modified oligonucleotide primers. Modification can be made with any group capable of covalently linking to the polymer to be formed by the selected prepolymer.

The preparation of oligonucleotide conjugates is generally accomplished through the use an oligonucleotide modified with a primary amine (Agrawal, S. (1994) Functionalization of oligonucleotides with amino groups and attachment of amino specific reporter groups. Methods in Molecular Biology 26; Protocols for Oligonucleotide Conjugates. (S. Agarwal, Ed.) pp. 73-92, Humana Press, Totowa, N.J. (Review), Meyers, R. (1994) Incorporation of Modified Bases into Oligonucleotides. Methods in Molecular Biology 26; Protocols for Oligonucleotide Conjugates. (S. Agarwal, Ed.) pp. 93-120, Humana Press, Totowa, N.J. (Review)). In most cases, amide or thiourea bonds are formed with conjugars containing an activated carboxyl or isothiocynate (ITC) functionality.

Although functionalization of many conjugars is routine, a number of conjugars have proved to be very difficult to transform into activated carboxyl or ITC derivatives either because of the complex synthesis involved or the inherent instability of the final compound. In an effort to circumvent these difficulties the coupling partners have been reversed placing the carboxylic acid function on the oligonucelotide, and the amine on the conjugar. The literature contains several examples of 5′ terminal oligonucleotide linkers that contain a carboxyl funtionality. Kremsky et al. ((1987) Immobilization of DNA via oligonucleotides containing and aldehyde or carboxylic acid group at the 5′ terminus. Nucleic Acids Research 15, 2891-2909), describe conjugation with a protected 5′ terminal oligonucleotide carboxyl group requiring cleavage of the methyl ester protecting group, followed by in situ activation with N-hydroxysuccinimide (“NHS”) and a coupling reagent to achieve conjugation.

In another approach, the protecting group is a benzyl ester, which can be directly coupled to an amine (Endo, M., Gaga, Y., and Komiyama, M., (1994) A novel phosphoramidite for the site-selective introduction of functional groups into oligonucleotides via versatile tethers. Tetrahedron Letter 33, 3879-3882). U.S. Pat. No. 5,663,242 describes 5′ end-attachment of oligonucleotides to polyacrylamide solid supports via a thioether linkage. A thiol-derivatized oligonucleotide is reacted with a reactive carbon center-derivatized polyacrylamide support (e.g., bromoacetyl-derivatized polyacrylamide support), or conversely, a reactive carbon center-derivatized oligonucleotide (e.g., a bromoacetyl-oligonucleotide) is reacted with thiol-derivatized polyacrylamide support to produce a polyacrylamide support with 5′-end attached oligonucleotides.

Another approach describes the formation of a phosphoramidate bond between a 3′ or 5′ phosphorylated oligonucleotide and an amino acid, followed by subsequent activation of the carboxyl moiety with carbodiimide (Gottikh, M., Asseline, U., and Thoung, N. T. (1990) Synthesis of oligonucleotides containing a carboxyl group at either their 5′ end or their 3′ end and their subsequent derivatization by an intercalating agent. Tetrahedron Letters 31, 6657-6660).

A recent method has employed direct co-polymerization of an acrylamide-derivatized oligonucleotide. For instance, ACRYDITE® (Mosaic Technologies, Boston, Mass.) is an acrylamide phosphoramidite that contains an ethylene group capable of free radical polymerization with acrylamide. Acrydite-modified oligonucleotides are mixed with acrylamide solutions and polymerized directly into the gel matrix (Rehman et al., Nucleic Acids Research, 27, 649-655 (1999). This method relies on acrylamide as the monomer. Depending on the choice of chemical functionality, similar problems in the stability of attachment, as with the above-mentioned methods, also result. In one embodiment, the primers are Acrydite® modified oligonucleotide primers and the prepolymer is acrylamide. Concentration of primers may be selected to control the desired probe density of the final patterned hydrogel, as detailed below.

Published US patent application no. 20030096265 describes a method of incorporating [2+2] photoreactive sites into oligonucleotides using photoreactive phosphoramidites. Using this method hydrogel can be formed by polymerizing acrylamide in a controlled fashion to obtain a “prepolymer.” The prepolymer may then be coated on a solid support, such as a glass microscope slide and photochemically crosslinked. Using [2+2] cycloaddition chemistry, photoreactive oligonucleotide primers, including DNA, RNA, and modifications thereof, can be attached to the hydrogel.

The prepared prepolymer mix is cured, using the method appropriate to the selected prepolymer, to form the hydrogel substrate for use in HLPE. In an embodiment having acrylamide as the prepolymer, curing is performed chemically through the addition of tetramethylethylenediamine (TEMED) and ammonium persulfate. Preferably the resulting hydrogel has viscosity and wetting properties similar to that of water. At least a portion of the modified oligonucleotide primers are covalently incorporated into the hydrogel matrix. In one embodiment, the modified primers are mobile in the cured hydrogel, but only within a distance proportional to the length of the crosslinking group. A wash is performed to remove any unincorporated primer. The cured hydrogel is subsequently wetted with a solution containing at least polymerase, deoxyribonucleotide triphosphates (dNTP: i.e., dATP, dCTP, dGTP, and dTTP), and buffer, in preparation for contact with the master array.

Biological materials that are employed as capture agents or probes can be any of a wide variety well known in this art. They may run the gamut from DNA sequences and peptides through much larger molecules, such as antibodies; even living cells may be attached at distinct spatial locations to the porous hydrogel using appropriate complementary linkers. Many other such binding pairs in addition to the chelators and biotin-avidin are well known in the art.

The invention also provides a hydrogel polymer blend composition comprising: (a) a first polymer comprising a photocrosslinked functionality, and (b) a second polymer comprising (i) one or more functionalities for selectively binding a biomolecular analyte by non-covalent binding, (ii) one or more functionalities for selectively binding a biomolecular analyte by covalent binding, or combinations thereof. In a preferred embodiment, the second polymer comprises (i) one or more functionalities for selectively binding a biomolecular analyte by non-covalent binding. In another preferred embodiment, the second polymer comprises (ii) one or more functionalities for selectively binding a biomolecular analyte by covalent binding. Polymers that may be used as substrates include, but are not limited to: poly(polyethylene glycol)methacrylate (PPEGMA); polyalkyleneamine (PAI); polyethyleneimine (PEI); polyacrylamide; polyimide; and various block co-polymers. Also provided is a hydrogel coating kit comprising: (a) a first composition comprising a first polymer comprising a photocrosslinkable functionality, wherein the first polymer optionally also comprises functionality for selectively binding a biomolecular analyte, and (b) a second composition comprising a second polymer comprising (i) functionality for selectively binding a biomolecular analyte, wherein the functionality for selective binding a biomolecular analyte in the first polymer and the second polymer can be the same or different.

Although the characteristics of the support may vary depending upon the intended use, the shape, material and surface modification of the substrates must be considered. Although it is preferred that the substrate have at least one surface which is substantially planar or flat, it may also include indentations, protuberances, steps, ridges, terraces and the like and may have any geometric form (e.g., cylindrical, conical, spherical, concave surface, convex surface, string, or a combination of any of these). Suitable support materials include, but are not limited to, glasses, ceramics, plastics, metals, alloys, carbon, papers, agarose, silica, quartz, cellulose, polyacrylamide, polyamide, and gelatin, as well as other polymer supports, other solid-material supports, or flexible membrane supports. A preferred embodiment of the support is a plain 2.5 cm×7.5 cm glass slide with surface Si—OH functionalities.

In some embodiments, it may be found useful to select a support material having UV, IR, or visible light transmission properties, for use with light-based detection technologies. The plate may be optionally coated with a reflective layer, as also well known in this art. The reflective layer should preferably cover substantially all of the surface region of the substrate where the probes will be attached, i.e. the array region; however, often a reflective coating that covers the entire upper surface of the substrate is used for manufacturing convenience. The reflective layer may be a reflective metal, e.g., aluminum, silver, gold, rhodium etc., which provides a mirrored layer. By reflective metal is meant a metal that reflects at least 90% of incident light in the wavelength region of interest, generally visible (400-800 nm), and possibly including longer wavelengths in the near infrared, such as 800-1100 nm, with very little (at or near 0%) light being refracted into the medium. Such a thin metal layer may be provided using any of the conventional vapor coating or other coating methods well known in the art for providing such mirror coatings. The thickness of the layer is not of particular consequence so long as there is continuity, but a layer about 0.01 micron to about 15 microns thick is generally used when such a layer is included.

### C. Replica Hydrogel Arrays

In the method of the invention, a master array, that includes a substrate having a first set of molecules bound to at least one surface in a pattern, is used to induce the assembly of a second set of molecules via reversible supra-molecular chemistry (e.g., hydrogen bonds, ionic bonds, covalent bonds, van der Waals bonds, or a combination thereof). The second set of molecules are immobilized on the crosslinked polymer strands of a hydrogel. Optionally, this is followed by a step where the second molecule is allowed to polymerize using the first molecule as a template, such as in a primer extension along a template strand with nucleic acid molecules. Then, the reversible bonds between the first set of molecules and the second set of molecules are broken and the hydrogel bearing a replica of the master array is removed.

The bonds formed between the first set of molecules and the second set of molecules may be hydrogen bonds, ionic bonds, covalent bonds, van der Waals bonds, or a combination thereof. Preferably, the bonds formed between the first set of molecules and the second set of molecules are hydrogen bonds. In one embodiment, the bonds between the first set of molecules and the second set of molecules are broken by applying heat. In another embodiment, the bonds between the first set of molecules and the second set of molecules are broken by contacting the bonds with a solution having a high ionic strength. In yet another embodiment, the bonds between the first set of molecules and the second set of molecules are broken by contacting the bonds with a solution having a high ionic strength and applying heat. Alternatively, the bonds between the first set of molecules and the second set of molecules are broken by contacting them with a solution containing an enzyme that breaks the bonds. Typically, the bonds between the first set of molecules and the second set of molecules can be broken without breaking most of the bonds between the second set of molecules and the second hydrogel substrate.

In one embodiment, the first set of molecules includes two or more different molecules that have recognition components that are different nucleic acid sequences. In this embodiment, the second set of molecules includes molecules that have a nucleic acid sequence, or a portion thereof, that is complementary to at least one of the molecules of the first set of molecules. In one embodiment, hydrogen bonds between hybridized molecules from the first set of molecules and the second set of molecules are broken by contacting the hydrogen bonds with an enzyme. For example, an enzyme from the helicase family of enzymes may be use to break the bonds between hybridized nucleic acid molecules. Various helicases have been reported to dehybridize double stranded oligonucleotides. For example, E. coli Rep, E. coli DnaB, E. coli UvrD (also known as Helicase II), E. coli RecBCD, E. coli RecQ, bacteriophage T7 DNA helicase, human RECQL series; WRN(RECQ2), BLM(RECQL3), RECQL4, RECQL5, S. Pombe rqh1, C. elegance T04A11.6 (typically, the helicase name is derived from the organism from which enzymes comes). Cofactors which stabilize single stranded DNA, such as single stranded DNA binding protein (SSB), could be added. Another method of breaking the bonds between two hybridized nucleic acids would be to use a restriction endonuclease, which recognizes specific base sequence and cleaves both strands at a specific location in the nucleic acid sequence.

Alternatively, the bonds between the first set of molecules and the second set of molecules are broken by applying heat, by contacting the bonds with a solution having a high ionic strength, or by contacting the bonds with a solution having a high ionic strength and applying heat.

The hydrogel for nucleic acid-based microarrays contains a plurality of oligonucleotide primers attached to the crosslinked polymers of the hydrogel. The primers comprise sequences complementary to sequences of nucleic acids attached to the master template. The hydrogel is wetted with a suitable buffer solution for primer extension. The solution contains reagents such as dNTPs and enzymes like DNA polymerases necessary for primer extension. In some embodiments the DNA polymerase is suitable for thermal cycling. The wetted hydrogel is then contacted with the patterned, DNA master array. In some embodiments the contact is mediated by a mechanical printing device to ensure reproducibility. In some embodiments, reagents for primer extension can be supplied to the hydrogel following contact with the master template.

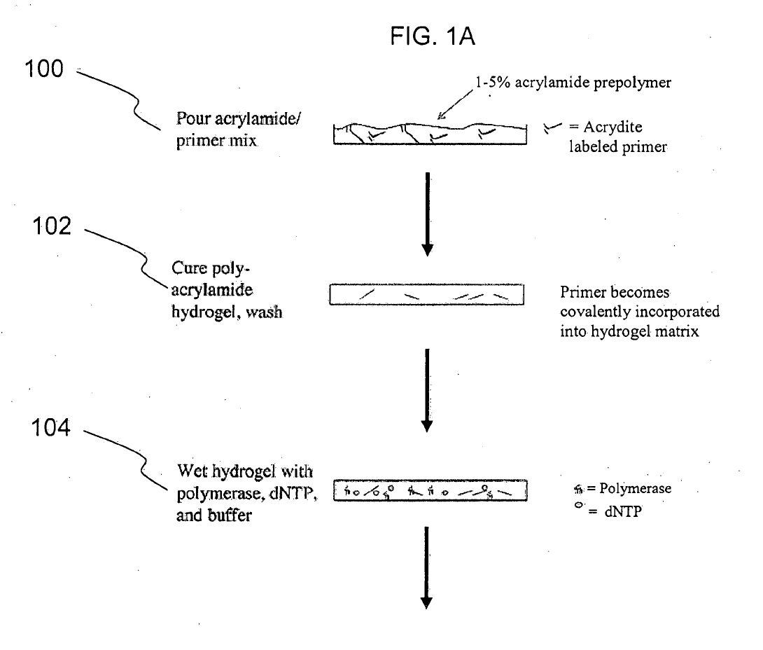

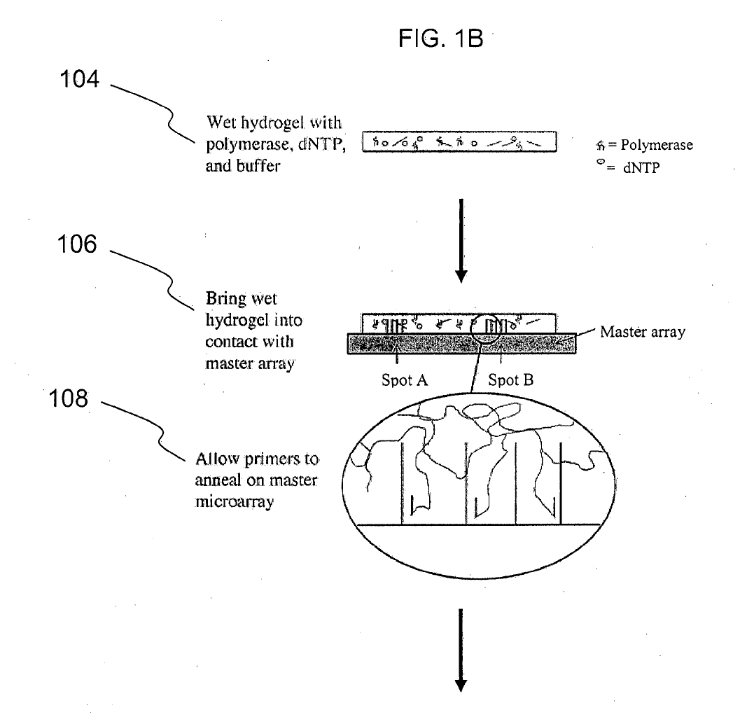

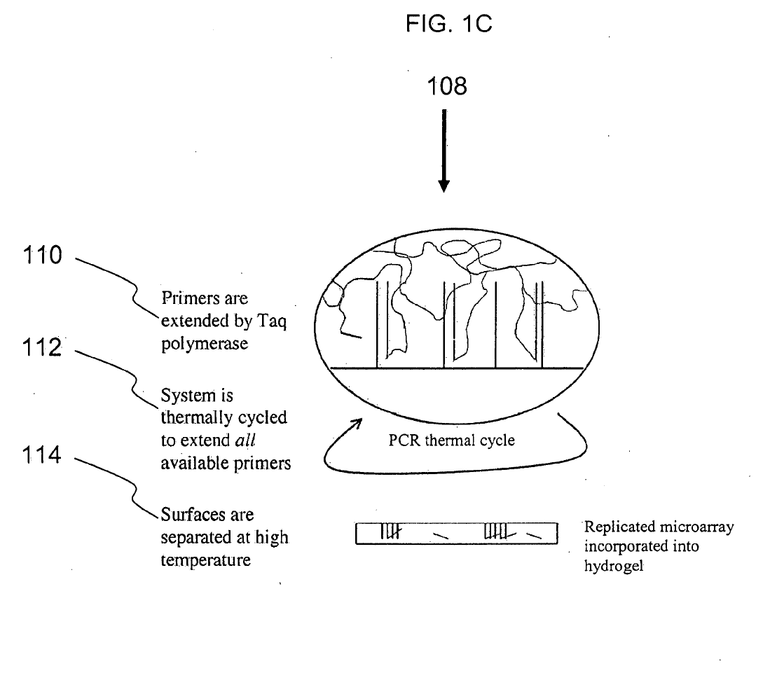

Once the hydrogel is in contact with the surface of the master microarray, the primers are allowed to anneal with the master strands. The hydrogel is wetted with solution containing nucleic acid polymerase and dNTPs, allowing the primers to extended along the template master strands as shown in FIG. 1C. As used herein, “nucleic acid polymerase” refers to an enzyme that catalyzes the polymerization of nucleoside triphosphates. Generally, the enzyme will initiate synthesis at the 3′-end of the primer annealed to the target sequence, and will proceed in the 5′-direction along the template until synthesis terminates. Known DNA polymerases include, for example, E. coli DNA polymerase I, T7 DNA polymerase, Thermus thermophilus (Tth) DNA polymerase, Bacillus stearothermophilus DNA polymerase, Thermococcus litoralis DNA polymerase, Thermus aquaticus (Taq) DNA polymerase and Pyrococcus furiosus (Pfu) DNA polymerase, Thermococcus litoralis (Vent) DNA polymerase and Phi29 DNA polymerase. Chimeric DNA polymerases with thermostability, processivity and resistance to PCR inhibitors may be used. The protein chimeras contain polymerase domains fused with helix-hairpin-helix (HhH) domains derived from topoisomerase V of M. kandleri (TOPOTAQ DNA polymerases). The advantages of the chimeric DNA polymerases allow for cycle sequencing and PCR in high salt concentrations and at temperatures inaccessible for other DNA polymerases.

The master array-hydrogel complex is subjected to one or more PCR thermocycles to extend the incorporated primers. Each thermocycles comprises at least one or more of the following steps: 1) a denaturing step, 2) an annealing step, and 3) an extension step. In one embodiment, the PCR thermocycling substantial follows the steps detailed in Saiki, R. K., D. H. Gelfand, S. Stoffel, S. J. Scharf, R. Higuchi, G. T. Horn, K. B. Mullis, and H. A. Erlich. 1988. Primer-directed enzymatic amplification of DNA with a thermostable DNA polymerase. Science 239:487-491. It is understood that variations and modifications of PCR known in the art, may be employed with the methods described herein. PCR thermocycles are repeated so as to extend 50%, 60%, 70%, 80%, 90%, 95%, 99%, or 100% of the primers incorporated into the hydrogel. Preferably, sufficient thermocycles are carried out to extend all or nearly all of the incorporated primers. Upon completion of the PCR thermocycling, the hydrogel, now having the microarray pattern of the master, is separated from the master array. Preferably, separation is performed at a temperature at least equal to the denaturing temperature of the DNA molecules employed.

The resulting hydrogel microarray may have a greater density of DNA probes, arrayed in the desired pattern, that the master array, depending on the concentration of primers employed and the number of PCR thermocycles.

Modifications and adaptations of the HPLE methods described herein, may be more fully understood with reference to the examples provided below.

D. Hydrogel Primer Extension with Thermocycling

FIGS. 1A-1C depict an exemplary process and system for replicating hydrogel DNA microarrays via thermal cycling. It should be recognized that the exemplary process may be adapted for the synthesis of other types of microarrays.

With reference to FIG. 1A, in step 100, a prepolymer mix containing from 1-5% (w/v) acrylamide and selected, Acrydite® modified (i.e., labeled) oligonucleotide primers is poured into a gel tray. In step 102, the prepolymer mix is chemically cured using TEMED and ammonium persulfate to form a polyacrylamide hydrogel. The hydrogel so formed, being a low percentage hydrogel, has a viscosity and wetting properties similar that of water. A substantial percentage of the Acrydite® modified primers become covalently incorporated into the hydrogel matrix and are spatially localized in the hydrogel, due to the covalent incorporation. Further in step 102, a wash is performed to remove any unincorporated primer. In step 104, the cured hydrogel is wetted with a solution containing buffer, DNA polymerase (e.g., Taq polymerase), and dNTP.

With reference to FIG. 1B, in step 106, the wetted hydrogel is brought into contact with a DNA master array, having a desired pattern of linked DNA polymers (probes) on its surface. The master array may be one prepared by any method known in the art. In one embodiment, the master array is prepared by first forming a pattern of reactive material (e.g., gold) on a substrate using a standard lithography technique, such as electron beam lithography followed by immersion in a solution of thiolated DNA molecules. Preferably, the oligonucleotide primers of step 100 were selected based on their ability to hybridize with the linked DNA polymers of the master array. Due to the low percentage of hydrogel, conformal contact between the wetted hydrogel and the DNA master array can be made without damage to the pattern on the master array. In step 108, a portion of the modified primers covalently incorporated into the hydrogel are allowed to anneal (i.e., hybridize) with the DNA of the master array, typically, at a temperature of 50-64° C. during an annealing step.

With reference to FIG. 1C, in step 110, the annealed primers are extended by the polymerase of the wetted hydrogel, typically at a temperature of 70-74° C. during an extension step. In step 112, PCR thermocycling is performed to extend all or substantially all of the available primers incorporated into the hydrogel. In one embodiment, the PCR thermocycling involves the sequential steps of denaturing, annealing, and extension. In an embodiment, the denaturing step typically involves a temperature of 94-96° C., held for 1-9 minutes to ensure denaturing of the master array DNA and the extended primers. In step 114, the hydrogel, now having the desired DNA microarray pattern imbedded in its surface, is separated from master array. Due to the thermal cycling, the hydrogel of this method may potentially have a greater number of DNA probes (polymers) than present in the master array. Accordingly, the disclosed method is inherently insensitive to accumulating damage on the master array (e.g., loss of linked DNA polymers on the master array surface). In one embodiment, the number of thermocycles performed are increased with extended use of a given master array, to ensure saturation of all DNA primers in the wetted hydrogels.

### E. Printing Device for Hydrogel Array Fabrication

The invention relates to a molecular printer for generating a complement image of a master, wherein the master has a first set of molecules bound to a first substrate. The molecular printer comprises comprising a device for delivering a second hydrogel substrate comprising a cross-linked polymer to a surface of the master, wherein the hydrogel is capable of attachment to a second set of molecules that are reversibly attached to the first set of molecules bound to the first substrate. The invention relates to a device that allows for providing a physical and chemical environment for dissociating the first and second set of molecules stamping the second set of molecules on the cross-linked polymer strands of the second hydrogel substrate. In this embodiment, the second set of molecules comprises a reactive functional group suitable for attaching to one or more attachment sites on the cross-linked polymer of the hydrogel; and a recognition component that allows it to reversibly bind to the first set of molecules.

In another embodiment, the second set of molecules is generated after the first and second substrates are brought into contact. The incoming hydrogel substrate comprises precursors of the second set (primer sequences in the case of nucleic acid molecules) which reversibly bind to the first set of molecules and under suitable conditions are modified to the second set of molecules. In a nucleic acid based HLPE system, the hydrogel contains attached primer oligonucleotides that bind to template nucleic acid strands of the template array and are elongated using DNA polymerase enzymes such as E. coli DNA polymerase I, T7 DNA polymerase, Thermus thermophilus (Tth) DNA polymerase, Bacillus stearothermophilus DNA polymerase, Thermococcus litoralis DNA polymerase, Thermus aquaticus (Taq) DNA polymerase and Pyrococcus furiosus (Pfu) DNA polymerase, Thermococcus litoralis (Vent) DNA polymerase, TOPOTAQ DNA polymerase and Phi29 DNA polymerase.

When the device is able to provide thermal cycling in the chamber where the master template array and the hydrogel are in contact in the presence of dNTPs and a thermostable DNA polymerase, the second set of molecules comprise an amplified complement of the template nucleic acid strands. The amplification products are attached to the hydrogel polymer strands and upon separation of the slides is stamped on the hydrogel array. The device also provides conditions such as heat as well as ports for supplying reagents that enable the dissociation process.

Generally, the apparatus comprises one or more chucks for holding the hydrogel substrate comprising the second set of molecules, one or more components for holding a master array in position for contacting the hydrogel substrate containing the second set of molecules or precursors thereof, or attachment sites therefor. The chuck holding the hydrogel substrate slidably operates in the apparatus to allow the hydrogel to come in contact with the master and then be separated and removed following stamping. In addition, the apparatus may include computer controlled means for transferring in a predetermined manner solutions and reagents from the reservoirs to the surface a master. Preferably the hydrogel is wetted with reagents (for example, thermostable DNA polymerase and dNTPs) that enable the stamping process. A clamp that secures the master to the second substrate during the stamping process may also be included in the apparatus of the invention. The temperature of the solution of the reagents and the vessel containing the master may also be controlled.

The apparatus may also include a reservoir containing a solution for breaking the bonds between the first and the second molecules, such as a solution having a high ionic strength or a solution containing an enzyme that will break the bonds, and a means for delivering the solution. In addition, after the second substrate has been bound to the second set of molecules, a heating element may be used to heat a solution in contact with the bound first and second sets of molecules to break the bonds. The computer controlled means for transferring solutions and controlling temperature can be implemented by a variety of general purpose laboratory robots, such as that disclosed by Harrison et al, Biotechniques, 14: 88-97 (1993); Fujita et al, Biotechniques, 9: 584-591 (1990); Wada et al, Rev. Sci. Instrum., 54: 1569-1572 (1983). Such laboratory robots are also available commercially, e.g. Applied Biosystems model 800 Catalyst (Foster City, Calif.).

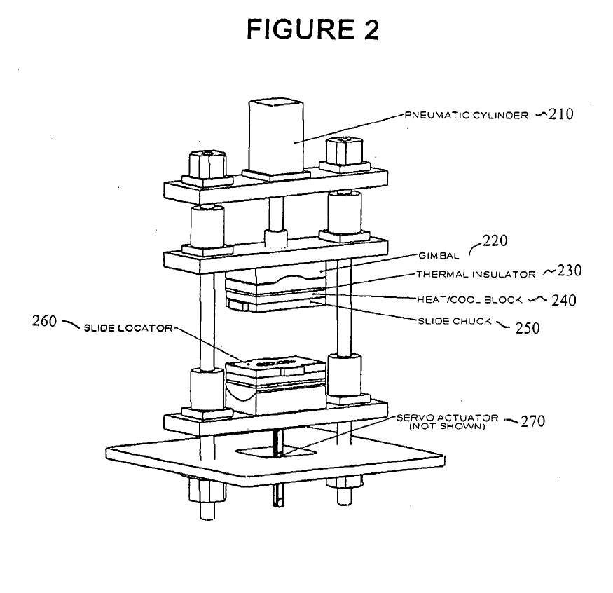

FIG. 2 shows an exemplary printing device for fabrication of hydrogel arrays by SuNS process. The user requirement for an instrument is a description of what The instrument meets user requirement. In one embodiment, the precise mechanisms by which these functions are performed is illustrated in the equipment illustrated in FIG. 2.

In FIG. 2, the slide chuck 250 allows the replica hydrogel slides to be vertically brought into contact and separated following stamping of the molecular features.

The lower slide locator 260 holds the master template array slide. In some embodiments the slide locator 260 further comprises an inlet and outlet for automated dispensing of stamping buffer onto the lower slide and removal following stamping. In some embodiments, the inlet and outlet are the same and are preferably connected to a pumping mechanism. The pumping mechanism is also able to circulate the stamping buffer.

The pneumatic cylinder 210 is optionally coupled with a servo actuator 270 to enable a precision motion profile to (a) cause bubble free spreading of stamping buffer across the interface of the master array and the hydrogel substrate; (b) make conformal contact between the slides; and following the stamping process, (c) separate the slides.

The slide chuck is positioned adjacent a thermal heat/cool block 240 in at least one direction. In some embodiments an thermal insulator 230 is positioned at the distal end of the thermal block 240 relative to the slide chuck 250, as seen in FIG. 2. The thermal block ensures proper thermal profile to initiate oligo linkage chemistry when the second set of molecules need to attach to the hydrogel polymer strands. In embodiments where the hydrogel comprises oligonucleotide primer sequences, the heat/cool block provides conditions for amplification of the master array strands using primer sequences attached to the hydrogel. Hydrogels comprise primer oligonucleotides attached to polymer strands comprising the hydrogel. Given the pseudo-aqueous nature of the hydrogel, primer sequences are able to navigate between the distance of each cross-link position. Thus a number of primers are available during thermal cycling for amplification. In some embodiments, primers comprise an unique sequence complementary to a portion of a sequence of master array strands.

The device also allows for adjustment of the pressure profile during contact between the master and the hydrogel to optimize transfer efficiency. Sufficient pressure is applied to ensure that the hydrogel and solutions and reagents therein are in sufficient contact with the master array surface, for reasonably high levels of binding, amplification and transfer to occur. While the movement of the slide chuck holding the hydrogel substrate is controlled by the pneumatic cylinder 210, an orthogonal, low-friction gimbal mechanism 220 ensures that pressure distribution across slide interface will be highly uniform and cause uniform transfer of the second set of molecules to the hydrogel across the entire surface of the master. The servo actuator 270 may also act to align hydrogel substrates with the master array during repeated stamping procedures.

The device may optionally include safety features such as a light curtain which disengages the device if an object enters the enclosure. Optionally, the printing device may include or be coupled with a slide loading/unloading tool for ease of operation and slide alignment.

The printing device is engineered to precisely control and accurately measure the parameters that determine efficiency in SuNS printing. In addition, the reproducibility of the process will be ensured by automation.

Features of a preferred printing device include: maintaing consistent temperature profile during contact; reproducible temperature profile during separation; constant and uniform pressure profile during contact; and parallelism tolerance during conditions where the gimbal is slightly offset.

The stamping process (use of a “carrier system”) comprises: loading of template and replica surfaces into mobile carriers; making conformal contact between surfaces in the printing device; providing a thermal profile for biomolecular reactions at the surfaces of the contacted arrays; and eventual separation of the hydrogel substrate from the master. Preferably, the instrument carries out the process with minimal damage to the master array which can be regenerated following a stamping procedure.

### Examples

### Example 1

### Quality Control of the Printing Device

Quality control for spotted microarrays has become an intense area of research. In fact, several softwares have been developed to address this issue, as it is so essential to the quality of the resulting assay data. Doelan (Bioinformatics 2005 21(22):4194-4195) is an example of such a software, and is based on the principle of test suites. Tests are flexible and may be user defined. Tests performed on product arrays generated by the printing device monitor feature uniformity, feature morphology and probe density.

On a microarray platform, the microarray quality control manager takes a number of chips from one batch for validation, using various quality controls, such as SYBR green (whole labelling of nucleic acids; Shearstone, J. R., et al. (2002) Nondestructive quality control for microarray production. Biotechniques, 32, 1051-1057; Hessner, M. J., et al. (2004). Utilization of a labeled tracking oligonucleotide for visualization and quality control of spotted 70-mer arrays. BMC Genomics., 5, 12), self-hybridization experiments (the same RNA samples labelled with two dyes in both ways) or reference experiments for differential analysis. Taking the decision of validating a batch of chips is difficult, as many different parameters such as spot diameter, heterogeneous or absent spots have to be manually considered. In addition, spotting validation is a very subjective step so that the opinion about a batch may differ between two quality control managers. Using manually defined criteria for microarray quality, Doelan now allows an automated expertise of the quality of a batch of slides and automatically makes the decision of validating or rejecting a batch. Doelan also creates an output file describing batch quality

Arrays are randomly selected for QC analysis, and probes are labeled in one or more of the following three ways: a) labeling of total ssDNA with the SYBR Green II dye; b) labeling of each feature by hybridization with oligo, which is complementary to universal primer sequence, and c) labeling of spike-in control features with perfectly complementary spike-in oligo

### Example 2

### Methods for Detecting Binding Events on the Hydrogel Replica Array

In an usual assay, the replica microarray is exposed to a solution, usually aqueous, containing a sample of biological material under hybridization/binding conditions; the solution contains potential targets which have been tagged or labeled, either with a reporter or signal material or with a linker that will subsequently sequester a reporter material, and incubated. Label or tag is used to refer to a substituent that can be attached to a target, e.g., a nucleic acid sequence, which enables its detection and/or quantitation.

In one embodiment, the capture agent or any secondary agent that can specifically bind the capture agent may be labeled with a detectable label, and the amount of bound label can then be directly measured. The term “label” is used herein in a broad sense to refer to agents that are capable of providing a detectable signal, either directly or through interaction with one or more additional members of a signal producing system. Labels that are directly detectable and may find use in the present invention include, for example, fluorescent labels such as fluorescein, rhodamine, BODIPY, cyanine dyes (e.g. from Amersham Pharmacia), Alexa dyes (e.g. from Molecular Probes, Inc.), fluorescent dye phosphoramidites, beads, chemilumninescent compounds, colloidal particles, and the like. Suitable fluorescent dyes are known in the art, including fluoresceinisothiocyanate (FITC); rhodamine and rhodamine derivatives; Texas Red; phycoerythrin; allophycocyanin; 6-carboxyfluorescein (6-FAM); 2′,7′-dimethoxy-41,51-dichloro carboxyfluorescein (JOE); 6-carboxy-X-rhodamine (ROX); 6-carboxy-21,41,71,4,7-hexachlorofluorescein (HEX); 5-carboxyfluorescein (5-FAM); N,N,N1,N′-tetramethyl carboxyrhodamine (TAMRA); sulfonated rhodamine; Cy3; Cy5, etc. Radioactive isotopes, such as ³⁵S, ³²P, ³H, ¹²⁵I, etc., and the like can also be used for labeling. In addition, labels may also include near-infrared dyes (Wang et al., Anal. Chem., 72:5907-5917 (2000), upconverting phosphors (Hampl et al., Anal. Biochem., 288:176-187 (2001), DNA dendrimers (Stears et al., Physiol. Genomics 3: 93-99 (2000), quantum dots (Bruchez et al., Science 281:2013-2016 (1998), latex beads (Okana et al., Anal. Biochem. 202:120-125 (1992), selenium particles (Stimpson et al., Proc. Natl. Acad. Sci. 92:6379-6383 (1995), and europium nanoparticles (Harma et al., Clin. Chem. 47:561-568 (2001). The label is one that preferably does not provide a variable signal, but instead provides a constant and reproducible signal over a given period of time. the employment of substrates having such a continuous slab of hydrogel can substantially increase the efficiency with which a microarray can be fabricated using the anchoring moieties uniformly dispersed throughout.

Although the invention has been described with reference to preferred embodiments and examples thereof, the scope of the present invention is not limited only to those described embodiments. As will be apparent to persons skilled in the art, modifications and adaptations to the above-described invention can be made without departing from the spirit and scope of the invention, which is defined and circumscribed by the appended claims.

The foregoing is offered primarily for purposes of illustration. It will be readily apparent to those of ordinary skill in the art that the operating conditions, materials, procedural steps and other parameters of the invention described herein may be further modified or substituted in various ways without departing from the spirit and scope of the invention. Thus, the preceding description of the invention should not be viewed as limiting but as merely exemplary. The disclosures of all U.S. patents and published patent applications set forth herein are expressly incorporated herein by reference.

We claim:

1. A printing device for generating on a hydrogel substrate a complement image of a master having a first set of molecules bound to a surface of a first substrate comprising:
a device for delivering a second hydrogel substrate comprising a cross-linked polymer to a surface of the master, wherein the hydrogel is capable of attachment to a second set of molecules that are reversibly attached to the first set of molecules bound to the first substrate, wherein the device provides conditions for dissociating the first and second set of molecules and stamping the second set of molecules on the cross-linked polymer strands of the second hydrogel substrate,
and further wherein, the second set of molecules comprises a reactive functional group suitable for attaching to one or more attachment sites on the cross-linked polymer of the hydrogel, and a recognition component that allows the second set of molecules to reversibly bind to the first set of molecules.

2. The device of claim 1 wherein the second set of molecules is generated after the first and second substrates are brought into contact, wherein the incoming hydrogel substrate comprises precursors of the second set, wherein the precursors reversibly bind to the first set of molecules and under suitable conditions are modified to the second set of molecules.

3. The device of claim 2 wherein, the hydrogel contains attached primer oligonucleotides that bind to template nucleic acid strands of the template array and are elongated using DNA polymerase enzymes.

4. The device of claim 3 wherein the DNA polymerase is selected from the group consisting of E. coli DNA polymerase I, T7 DNA polymerase, Thermus thermophilus (Tth) DNA polymerase, Bacillus stearothermophilus DNA polymerase, Thermococcus litoralis DNA polymerase, Thermus aquaticus (Taq) DNA polymerase and Pyrococcus furiosus (Pfu) DNA polymerase, Thermococcus litoralis (Vent) DNA polymerase, TOPOTAQ DNA polymerase and Phi29 DNA polymerase.

5. The device of claim 1 comprising a slide chuck which allows a replica hydrogel slide to be vertically brought into contact with a master array.

6. The device of claim 1 comprising a slide chuck positioned adjacent a thermal heat/cool block

7. The device of claim 1 comprising an orthogonal, low-friction gimbal mechanism 220 ensures that pressure distribution across slide interface.
